(19) United States
(12) Patent Application Publication
(10) Pub. No.: US 2006/0125606 A1
(43) Pub. Date: Jun. 15, 2006

(54) Method for reading an IC tag concealing part of data

(75) Inventors: Shang-Wei Chen, Tainan City (TW); Nien-Chu Wu, Taoyuan County (TW)

Correspondence Address: BRUCE H. TROXELL, SUITE 1404, 5205 LEESBURG PIKE, FALLS CHURCH, VA, 22041, US

(73) Assignee: Industrial Technology Research Institute

(21) Appl. No.: 11/082,767

(22) Filed: Mar. 18, 2005

(30) Foreign Application Priority Data
Dec. 14, 2004 (TW) 93138662

(51) Int. Cl. H04Q 5/22

(52) U.S. Cl. 340/10.51; 365/189.01

(57) ABSTRACT

A method for reading an IC tag concealing part of data of the present invention includes steps of: the IC tag receiving a signal transmitted by a reader through an antenna (the frequency of the signal is 13.56MHz, 433.92MHz, 860M˜930MHz (UHF), 2.45GHz, 5.8GHz or under 135KHz); decoding a fundamental frequency signal through a signal identification circuit of an analog circuit; decoding an instruction to be executed by the reader through an instruction coding module of a digital circuit; if the decoded instruction is a memory read instruction, conducting next step, otherwise, executing other instruction; obtaining a concealing bit from a configuration byte of a memory; judging whether a byte to be read by a reader has read restriction data; if yes, the IC tag entering a concealing mode, if not, obtaining a byte to be read by the reader through a memory access circuit; controlling an output program through an output circuit of a digital circuit; and a modulation circuit of the analog circuit transmitting the data to the reader through the antenna.

### FIELD OF THE INVENTION

The present invention relates to a method for reading an IC tag concealing part of data, and particularly to a method for limiting to read part of data (such as personal information of a client or shopping time) of a chip of an IC tag and leaving part of data (such as article making time, article number, name of manufacturer and so on) to be read at a market thereby preventing violation of privacy in application of radio frequency identification (RFID).

### BACKGROUND OF THE INVENTION

A radio frequency identification (RFID) system includes a reader, an IC tag and an application System. Through the wireless communication technology, digital data of a chip in the IC tag is transmitted to the reader in a non-contact communication manner. The data of the IC tag captured and identified by the reader are employed as a data source- of the application system for further processing, using and so on. Since the RFID technology is an automatic and non-contact information capturing and processing technology, it can make huge changes to manufacturing flow, article circulation and production management in future. Though the RFID technology can bring a lot of convenience and benefits, it also brings a problem of violation of a person's right to privacy.

Two reasons to cause conflict between the RFID technology and privacy are described as follows:

1) restriction of functions of the IC tag for the RFID due to low cost strategy. Since a manufacturer requires to reduce the price of the IC tag to be extremely low for saving cost, many functions of encryption for anti-false are not integrated in the IC tag.

2) the trend of distributed data. As more and more IC tags are used with erasable memory chips, many manufacturers distribute data (such as client information) at the IC tag. However, it is easy to read the data of the IC tag, which may cause violation of privacy.

Additionally, after a consumer brings article to a cashier for checking out in a shopping mall, a conventional magnetic bar code may cause a sensor to wrongly alarm due to incomplete demagnetization, which makes the consumer nervous and unhappy. Similarly, the same condition may happen to the RFID. Furthermore, if every article or medicine is defined in an RFID system, it is easy to peek and collect information of the article or medicine of each person within a certain distance, which may cause violation of privacy. Due to consideration of violation of privacy, some parties oppose enterprises to use the RFID technology.

For example, Benetton, a famous sports clothes manufacturing company in US, wanted to introduce the RFID technology into its brand of Sisley, which causes opposition of Consumers Against Supermarket Privacy Invasion and Numbering. So, the company adjusted to implement the RFID technology for reducing possibility of violating privacy.

In addition, EPC requires a kill function must be added in an RFID chip, that's after the article with an IC tag is sold, the chip of the IC tag is killed for protection of consumer privacy. However, the kill function is not perfect. Particularly when a consumer returns an article, it is inconvenient since the article number does not exist.

Referring to FIG. 1, a block diagram of functions of a conventional IC tag is shown. The IC tag includes an antenna 11, an analog circuit 12, a digital circuit 13 and a memory circuit 14 and so on. A high frequency signal transmitted by a reader (not shown) is received by the antenna 11 and then is decoded to generate a signal through a signal identification circuit 121, and then is decoded to generate an instruction to be executed through an instruction encoder 131. The instruction 132 is judged whether to read. If the instruction is to read, the data are read from a main memory 142 through a memory access circuit 134 (not using configuration byte 141 at this time), otherwise, other instruction 133 is executed. Finally, the data are transmitted to a modulation circuit 122 through an output circuit 135 and then are wirelessly transmitted to the reader through the antenna 11.

However, the above RFID has the following shortcomings:

1) The RFID data are not divided into article data and privacy data. When the data are transmitted to the reader, privacy may be violated.

2) The Kill function can wholly keep or delete the data but not identify private or open data. The consumer cannot judge whether the IC tag of the article receives a kill function instruction. So it is possible to wrongly regard a sold article as an unsold article, which causes trouble.

3) The kill function may be illegally activated, which causes the RFID system fail in reading the IC tag.

4) When the Kill function is activated to the sold article, the selling quantity cannot be identified for a shopping mall, which adversely affects operation of the RFID system.

5) When the consumer returns the article, since the IC tag is killed, it is inconvenient to deal with return.

From the above shortcomings of RFID system, it is known that the memory of the IC tag is wholly kept (at this condition privacy is not guarded) or wholly deleted (at this condition it is inconvenient to deal with return).

### SUMMARY OF THE INVENTION

To encounter the above shortcomings, the present invention provides a method for reading an IC tag concealing part of data. A main object of the present invention is to protect a chip of the IC tag through restricting to read part of data of the chip (such as personal information of client and shopping time) and leaving part of data to be read for a shopping mall (such as production time, article number, name of manufacturer), thereby preventing privacy from violating when using RFID.

Other objects, advantages and novel features of the present invention will be drawn from the following detailed embodiment of the present invention with attached drawings, in which:

### BRIEF DESCRIPTION OF THE DRAWINGS

FIG. 1 is a block diagram of functions of a conventional IC tag;

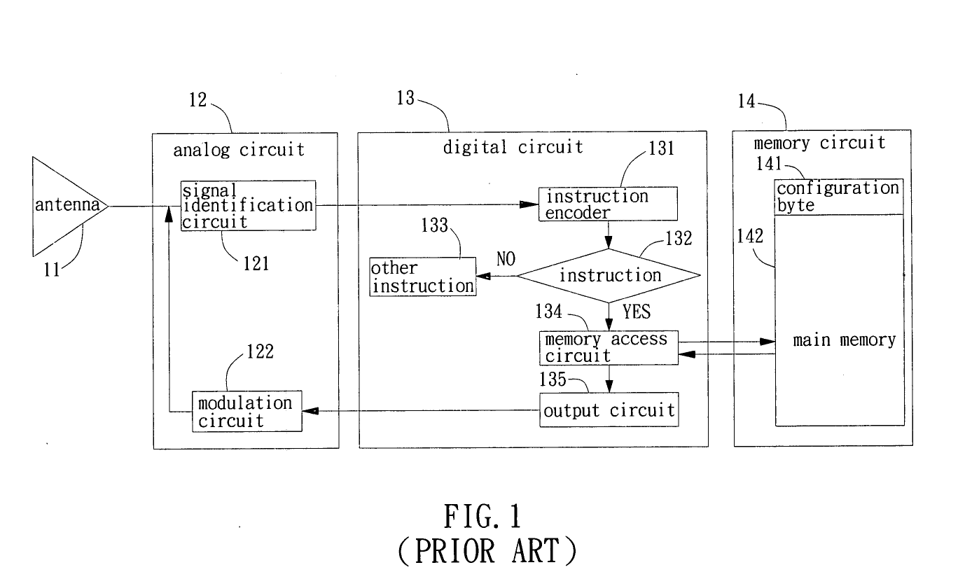

FIG. 2 is a block diagram of functions of an IC tag concealing part of data of the present invention;

FIG. 3 is a flow chart of operation of an IC tag concealing part of data of the present invention; and

FIG. 4 is a diagram of an RFID system concealing part of data of the present invention.

### DESCRIPTION OF THE PREFERRED EMBODIMENT

A radio frequency identification (RFID) system of the present invention is mainly used for non-contact identification and confirmation and mainly includes a reader, an IC tag/transponder, and an application system.

The RFID system is classified to be active and passive. For example, a passive system includes:

1) an IC tag. The IC tag includes a chip having functions of analog, digital and memory. The IC tag has a receiving antenna using different frequencies. The IC tag employs energy provided by a reader as operation energy thereof. Therefore the passive IC tag does not need an additional battery and so has advantages of miniaturization, cheapness and long life.

The IC tag is classified as follows in accordance with different memory designs:

a) Read only (R/O), that's a user can only read but not modify the data of the chip.

b) Write-once read-many (WORM), that's the user can only modify the data of the chip once but can repeatedly read many times.

c) Read-write (R/W), that's the user can optionally read and modify the data of the chip. An encryption may be used for preventing the data from optionally modifying.

2) a reader. The reader includes an analog control, a digital control and an optional single board computer. An antenna unit is disposed outside the reader. The reader can simultaneously identify several hundreds of different IC tags through binary search technology or anti-collision protocol, and so the reader can be employed as a device for identifying many target articles.

3) an application system. The application system communicates with or transmits a signal or an instruction to the reader and collects the digital data of the IC tag through wire or wireless communication. The application system may keep the digital data of the IC tag secret through encryption and decryption technology.

Through the above structures, the RFID digital data are changeable and negotiable. The application system may be combined with a network, a PC and a future information appliance for mass application in production, circulation, storage, transportation, intelligent home and digital life.

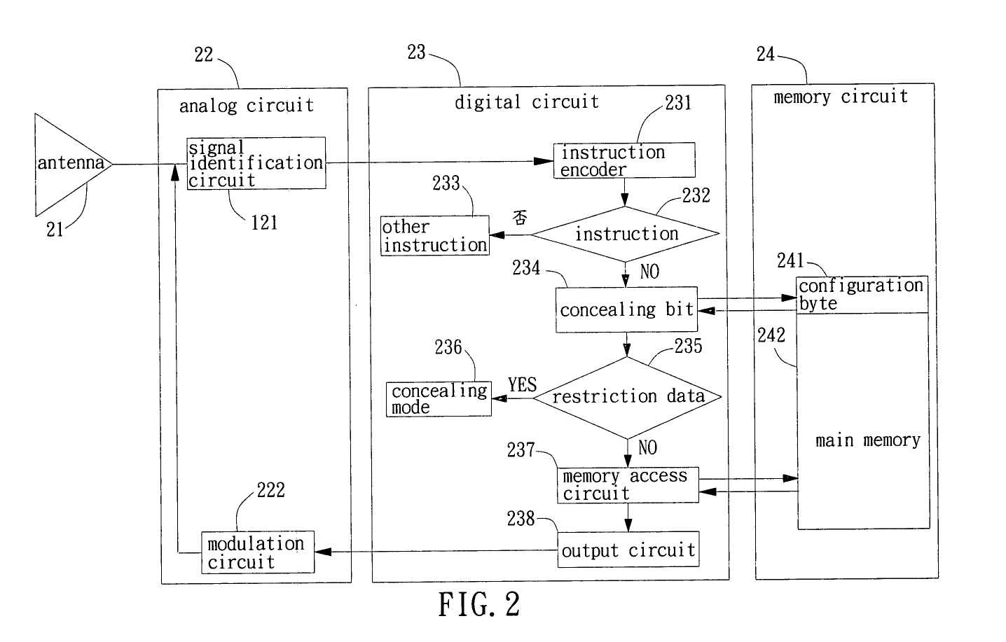

Referring to FIG. 2, a block diagram of functions of an IC tag concealing part of data of the present invention is shown. The IC tag mainly includes an antenna 21, an analog circuit 22, a digital circuit 23 and a memory circuit 24. A high frequency signal transmitted by a reader (not shown) is received by the antenna 21 and then is decoded to generate a signal through a signal identification circuit 221, and then is decoded to generate an instruction to be executed through an instruction encoder 231. The instruction 232 is judged whether to read a signal. A device for judging is used to judge the instruction whether to read the signal. If the instruction is to read the signal, a read restriction bit of a concealing bit 234 is read from a configuration byte 241 of the memory circuit 23. Otherwise, other instruction 233 is executed. Then judging whether the bit has read restriction data 235, if the bit to read is limited to read, enter a concealing mode 236; if not, the data of a main memory 242 are read from a memory access circuit 237. Finally, the data are transmitted to a modulation circuit 222 through an output circuit 238 and then are wirelessly transmitted to the reader through the antenna 21. The concealing mode may be one of the following modes:

1) sleeping mode, that's only waking instruction is received in sleeping mode and so no response is made to a common read state.

2) no action, that's no information is provided to the reader.

3) transmitting at least one set of bits meaningless to the reader. Continuous bits such as 1111 or 0000 are provided to the reader but the reader cannot judge the meaning of the bits.

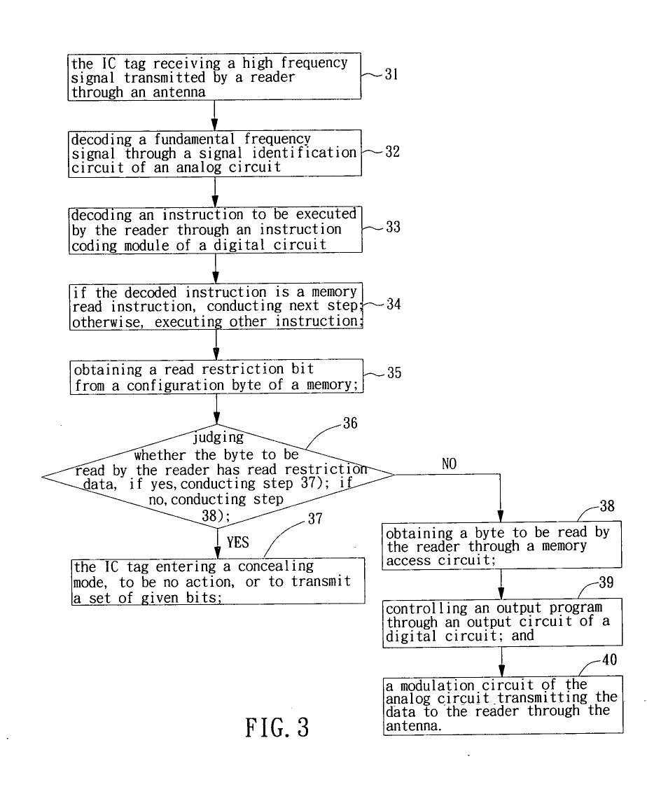

Referring to FIG. 3, a flow chart of operation of an IC tag concealing part of data of the present invention is shown. The operation of the IC tag includes the following steps:

31) the IC tag receiving a high frequency signal transmitted by a reader through an antenna;

32) decoding a fundamental frequency signal through a signal identification circuit of an analog circuit;

33) decoding an instruction to be executed by the reader through an instruction coding module of a digital circuit;

34) if the decoded instruction is a memory read instruction, conducting next step; otherwise, executing other instruction;

35) obtaining a read restriction bit from a configuration byte of a memory;

36) judging whether the byte to be read by the reader has read restriction data, if yes, conducting step 37); if no, conducting step 38);

37) the IC tag entering a concealing mode, wherein a circuit at the concealing mode is designed to be at sleeping mode, to be no action, or to transmit a set of given bits;

38) obtaining a byte to be read by the reader through a memory access circuit;

39) controlling an output program through an output circuit of a digital circuit; and

40) a modulation circuit of the analog circuit transmitting the data to the reader through the antenna.

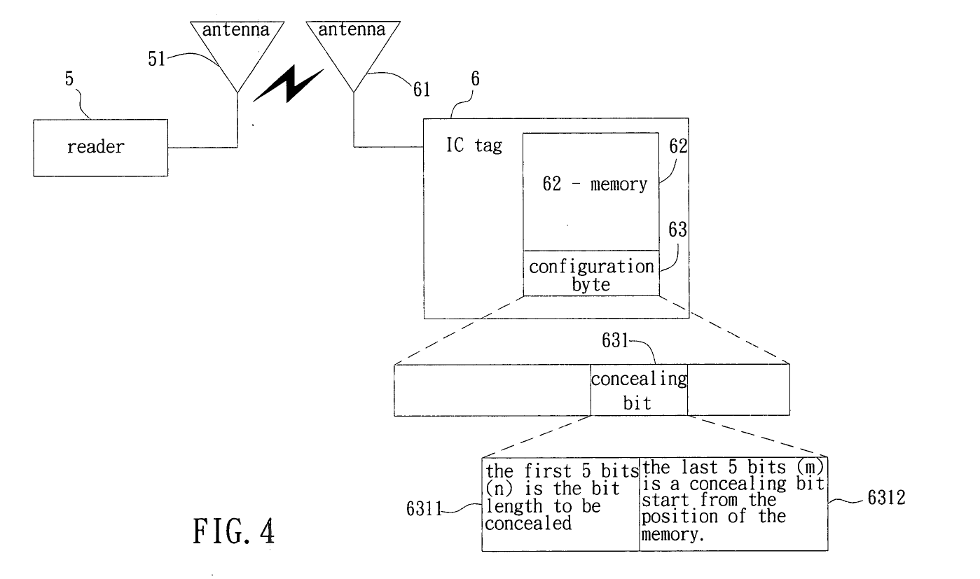

Referring to FIG. 4, a diagram of an RFID system concealing part of data of the present invention is shown. A read signal is transmitted from an antenna 51 of a reader 5 to an antenna 61 of an IC tag 6. A configuration byte 63 is defined at a memory 62 of the IC tag 6. The configuration byte 63 is an independent memory and so cannot be read through a common instruction thereby achieving function of keeping secret. The content is configured in accordance with different demands. Supposing the configuration byte 63 uses 10 bits to define function of a concealing bit 631, the first 5 bits (n) is defined to be the bit length 6311 to be concealed, and the last 5 bits (m) is defined to be a concealing bit start 6312 from the position of the memory. For example, that n=3 and m=5 means that the concealing start is from the 5th bit and the 5th, 6th and 7th bits (3 bits) are restricted to read thereby achieving to conceal part of data.

As mentioned above, the present invention achieves to protect the chip of the IC tag through restricting to read part of data of the chip (such as personal information of client and shopping time) and leaving part of data to be read for a shopping mall (such as production time, article number, name of manufacturer), thereby preventing privacy from violating when using RFID.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A method for reading an IC tag concealing part of data, comprising the following steps:
A) if a decoded instruction is a memory read instruction, conducting next step, otherwise, conducting other instruction;
B) obtaining a concealing bit from a configuration byte of a memory;
C) judging whether a byte to be read by a reader has read restriction data; and
D) the IC tag entering a concealing mode.

2. The method for reading an IC tag concealing part of data as claimed in claim 1, wherein in step C), if yes, conduct step D; if not, obtain a byte to be read by the reader through a memory access circuit, and then control an output program through an output circuit of a digital circuit.

3. The method for reading an IC tag concealing part of data as claimed in claim 2, wherein the output program comprises the following steps:
a) a modulation circuit of an analog circuit transmitting the data to the reader through an antenna;
b) the output circuit of the digital circuit controlling the output program; and
c) the modulation circuit of the analog circuit transmitting a signal to the reader through the antenna.

4. The method for reading an IC tag concealing part of data as claimed in claim 1, wherein the decoded instruction is generated through the following steps:
d) the IC tag receiving a signal transmitted by a reader through an antenna;
e) decoding a fundamental frequency signal through a signal identification circuit of an analog circuit;
f) decoding an instruction to be executed by the reader through an instruction coding module of a digital circuit; and
g) if the decoded instruction is a memory read instruction, conducting next step; otherwise, executing other instruction.

5. The method for reading an IC tag concealing part of data as claimed in claim 4, wherein the frequency of the signal transmitted by the reader and received by the antenna is 13.56 MHz, 433.92 MHz, 860M˜930 MHz (UHF), 2.45 GHz, 5.8 GHz or under 135 KHz.

6. The method for reading an IC tag concealing part of data as claimed in claim 1, wherein the concealing mode is a sleeping mode.

7. The method for reading an IC tag concealing part of data as claimed in claim 1, wherein the concealing mode is to be no action.

8. The method for reading an IC tag concealing part of data as claimed in claim 1, wherein the concealing mode is to transmit at least one set of bits meaningless to the reader.

9. The method for reading an IC tag concealing part of data as claimed in claim 1, wherein an application system communicates with a reader, or transmits a signal and an instruction and collects the digital data of the IC tag through wire or wireless communication.

10. The method for reading an IC tag concealing part of data as claimed in claim 1, wherein the memory is a write-once read-many memory or a read-write memory.
